(19) United States
(12) Patent Application Publication
(10) Pub. No.: US 2009/0043739 A1
(43) Pub. Date: Feb. 12, 2009

(54) METHOD OF DISPLAYING CUSTOMIZED DATA AND BROWSER AGENT

(75) Inventor: Hyung-tak CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/022,588

(22) Filed: Jan. 30, 2008

(30) Foreign Application Priority Data
Aug. 7, 2007 (KR) 10-2007-0079140

(51) Int. Cl. G06F 17/30

(52) U.S. Cl. 707/3; 707/E17.071

(57) ABSTRACT

Provided are methods and apparatuses to display customized data. A browser agent of an Internet protocol television (IPTV) displays customized data. The browser agent includes a usage pattern monitor which monitors a user's usage pattern of the IPTV; and a user interest data analyzer which analyzes the usage pattern obtained by the usage pattern monitor to obtain information on what the user is interested in. Accordingly, the method of displaying customized data and the browser agent enable to automatically search and provide data in which a user is usually interested so that the user can view a huge amount of data more promptly and conveniently.

### CROSS-REFERENCE TO RELATED PATENT APPLICATIONS

This application claims the priority from Korean Patent Application No. 10-2007-0079140, filed on, Aug. 7, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to Internet protocol television (IPTV), and more particularly, to displaying customized data using an IPTV, and a browser agent to support the displaying.

2. Description of the Related Art

Recent advances have led to the development of high-speed Internet technology, where the transmission rate of data over a communication network has been increased dramatically. Such high-speed Internet technology, in combination with digital TV technology has led to the production of Internet protocol television (IPTV), which is a new form of TV.

An IPTV allows services such as a triple play service (TPS) which has high-speed Internet, Internet telephone, and Internet broadcasting combined with one another. Under the TPS system, the IPTV can provide users with functions including live TV, a web browser, video on demand (VoD), a personal video recorder (PVR), audio on demand (AoD), and a game player.

When a user wants to view a broadcasting program using an IPTV, the user may watch the program in real time (live TV), or may view the program later any time when the user wants using a VoD function. Also, since the IPTV provides a PVR function, the user may save a desired broadcasting program in a memory included in the IPTV and reproduce the program to watch it whenever he/she wants.

Moreover, since the IPTV is capable of two way communication, it can be used for Internet searching. In this case, the IPTV acts as a personal computer (PC) for the Internet searching.

However, when a user searches for information using the IPTV, the IPTV is less convenient and consumes more time when compared to a PC. This is because the user uses a remote controller and/or a virtual keyboard to input keywords to the IPTV while the user uses a keyboard or a mouse to input keywords when the user uses a PC. Such problems will be explained in detail with reference to FIG. 1. FIG. 1 shows a display unit 11 of an IPTV, and the display unit 11 displays a browser for searching for information. The browser includes a keyword input window 12 and a virtual keyboard 13. A user selects a character on the virtual keyboard 12 using number keys or direction keys on a remoter controller so as to input a keyword. Thus, it is more time-consuming and inconvenient to input the keyword using a remote controller than using a keyboard. Moreover, since a huge amount of information is flooding on the Internet, a user needs to input more keywords to obtain the information he/she really wants, and thus the user will have more difficulties using the remote controller.

### SUMMARY OF THE INVENTION

The present invention provides methods and apparatuses of displaying customized data which provides a user with data in which the user is interested by automatically searching and editing the data in order to resolve problems occurring in the course of web document searching using an Internet protocol television (IPTV) and a remote controller.

According to an aspect of the present invention, there is provided a browser agent of an Internet protocol television (IPTV) which displays customized data, the browser agent comprising: a usage pattern monitor which monitors a user's using pattern of the IPTV to obtain usage pattern information; and a user interest data analyzer which analyzes the usage pattern obtained by the usage pattern monitor to obtain user interest data on what the user is interested in.

According to another aspect of the present invention, there is provided a browser agent of an IPTV which displays customized data, the browser agent comprising: a web document search engine which searches for a plurality of web documents with reference to user interest data; and a mash-up manager which mashes-up the web documents searched by the web document search engine to obtain mashed-up data.

According to another aspect of the present invention, there is provided a method of acquiring user interest data in order to display customized data on an IPTV, the method comprising: monitoring a user's pattern of using the IPTV to obtain usage pattern data; and obtaining user interest data by analyzing the usage pattern data.

According to another aspect of the present invention, there is provided a method of mashing-up a document in order to display customized data on an IPTV, the method comprising: searching for a plurality of web documents with reference to user interest data; and mashing-up the searched web documents.

According to another aspect of the present invention, there is provided a method of searching for web documents in order to display customized data on an IPTV, the method comprising: searching for a plurality of web documents with reference to user interest data; and storing the searched web documents in a database.

According to another aspect of the present invention, there is provided a method of displaying customized data using an IPTV, the method comprising: reading out mashed-up data; configuring a web page for displaying the customized data using the mashed-up data; and displaying the web page.

According to the present invention, the method of displaying customized data and the browser agent enable to automatically search and provide data in which a user is usually interested so that the user can view a huge amount of data more promptly and conveniently.

### BRIEF DESCRIPTION OF THE DRAWINGS

The above and other features and advantages of the present invention will become more apparent by describing in detail exemplary embodiments thereof with reference to the attached drawings in which:

FIG. 1 is a drawing for explaining an Internet search method using a conventional Internet protocol television (IPTV) and a web browser for searching;

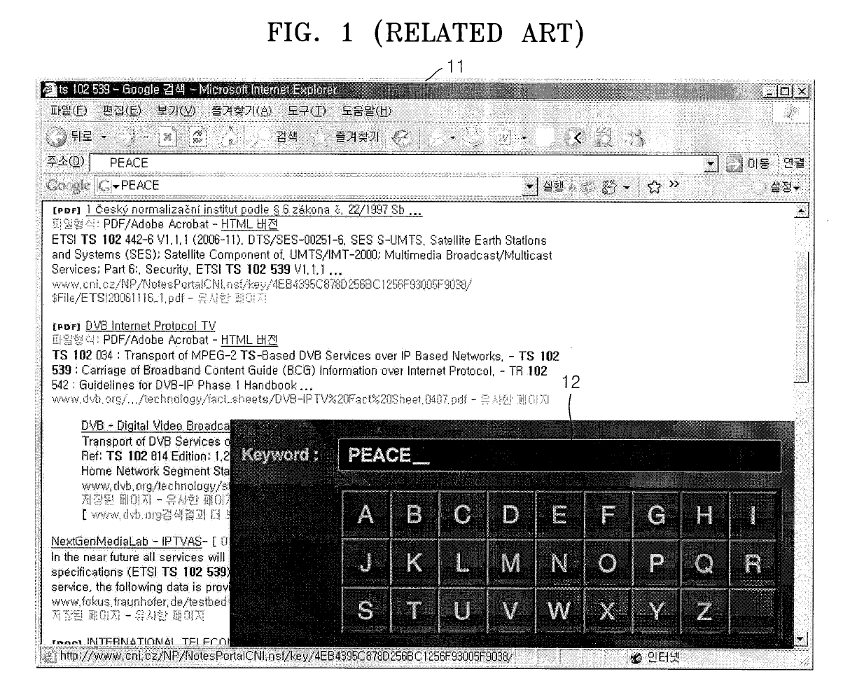

FIG. 2 is a functional block diagram of a browser agent according to an exemplary embodiment of the present invention;

FIG. 3 is a functional block diagram of a browser agent according to another exemplary embodiment of the present invention;

FIG. 4 shows an example of a web page for displaying customized data according to an exemplary embodiment of the present invention;

FIG. 5 is a flowchart illustrating a method of acquiring user interest data according to an exemplary embodiment of the present invention;

FIG. 6 is a flowchart illustrating a method of mashing-up a web document in detail, according to an exemplary embodiment of the present invention;

FIGS. 7A-7C are flowcharts each of which illustrates a method of searching for a web document according to exemplary embodiments of the present invention; and

FIG. 8 is a flowchart illustrating a method of displaying customized data in detail, according to an exemplary embodiment of the present invention.

### DETAILED DESCRIPTION OF EXEMPLARY EMBODIMENTS OF THE INVENTION

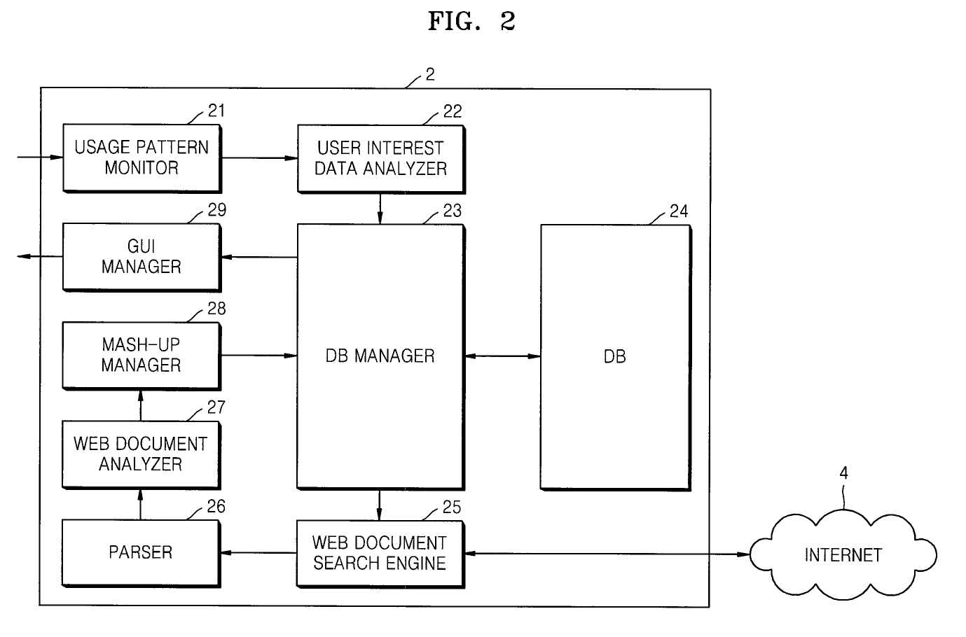

FIG. 2 is a functional block diagram of a browser agent 2 according to an exemplary embodiment of the present invention.

The browser agent 2 includes a usage pattern monitor 21, a user interest data analyzer 22, a database (DB) manager 23, a database 24, a web document search engine 25, a parser 26, a web document analyzer 27, a mash-up manager 28, and a graphic user interface (GUI) manager 29.

The browser agent 2 may be implemented as an element of an Internet protocol television (IPTV) or as an additional device (for example, a set-top box) which is separate from the IPTV.

The usage pattern monitor 21 monitors a user's pattern of using the IPTV to obtain information about a usage pattern.

A user uses a remote controller to control the IPTV. First, the user selects a desired function (for example, live TV, video on demand (VoD), or personal video recording (PVR)) of the IPTV. Then, the user selects a certain program or content to be reproduced. The usage pattern monitor 21 monitors inputs from the remote controller to obtain information (or usage pattern information) about which function of the IPTV the user selects, which web document the user views, or which program or content the user watches.

The user interest data analyzer 22 analyzes and arranges data which the user is interested in by using the usage pattern information obtained by the usage pattern monitor 21. The user interest data analyzer 22 analyzes a web document that the user views, a program or content that the user watches to extract the address (for example, URL or URI) and texts that the user clicked of the web document, the title, genre, and main character of the program or content. The user interest data analyzer 22 extracts the information in a form of keyword. Moreover, the user interest data analyzer 22 arranges extracted keywords by categorizing the keywords (or user interest data) based on predetermined standards or weighting the extracted keywords. The weight and arrangement of the extracted keywords will be described in detail later.

The user interest data obtained by analyzing and/or arranging the usage pattern information is stored in the database 24 by the DB manager 23. The DB manager 23 manages input and output between the user interest data analyzer 22 and the database 24.

The web document search engine 25 searches for web documents (or web files) on a regular basis or whenever the user wants. The web document search engine 25 searches the Internet 4 to detect a web document (or web file) with reference to a keyword (or user interest data) stored in the database 24.

The parser 26 parses the web documents detected by the web document search engine 25 so that the web document analyzing unit 27 can understand the web documents.

The web document analyzer 27 analyzes the parsed web documents to sort out which documents the user might be practically interested in. This is because some of the documents that are detected by the web document search engine 25 might not interest the user.

The standards for sorting out the web documents may include the use of weight of a keyword, excluding a document if the detected document was made before a certain time, and excluding a document if the document includes a particular word. For example, when the web document search engine 25 detects web documents by using a keyword “World Cup” as user data, some of the detected documents are excluded if the documents are about World Cup before the year of 2000 since the user is not interested in them.

The mash-up manager 28 reedits (or mashes-up) the documents sorted out by the web document analyzer 27. The reedited or mashed-up data is stored to the database 24 by the DB manager 23.

The mash-up manager 28 reedits a web document, for instance, by removing unnecessary images from the web document or changing the size or font of texts in the web document.

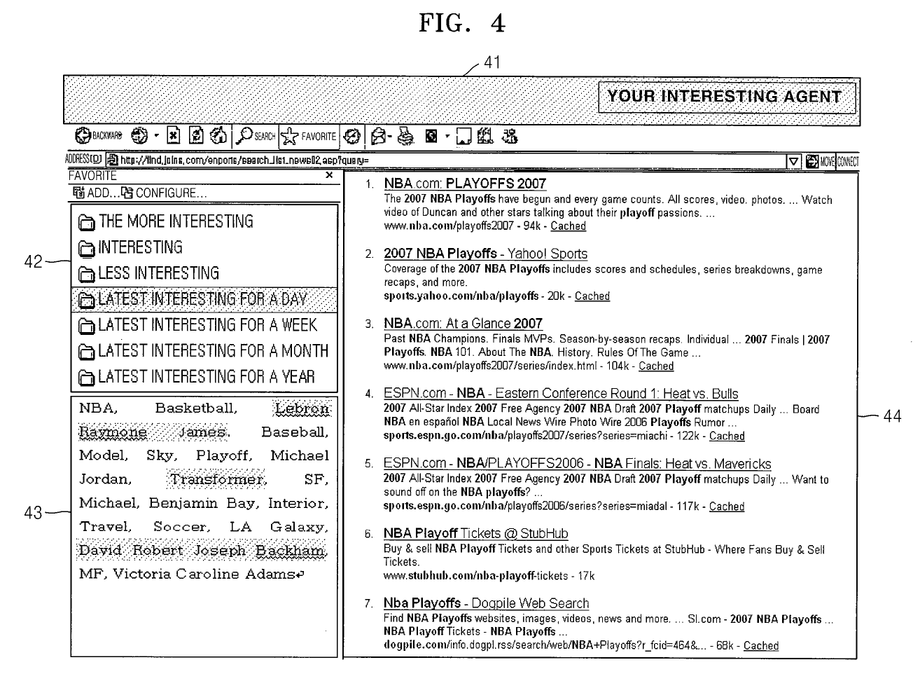

When a user's request occurs, the GUI manager 29 reads the mashed-up data from the database 24 and displays the data in a form of a web page on a display unit (not shown) of the IPTV according to a predetermined form. Such a web page, which includes customized data, is illustrated in FIG. 4.

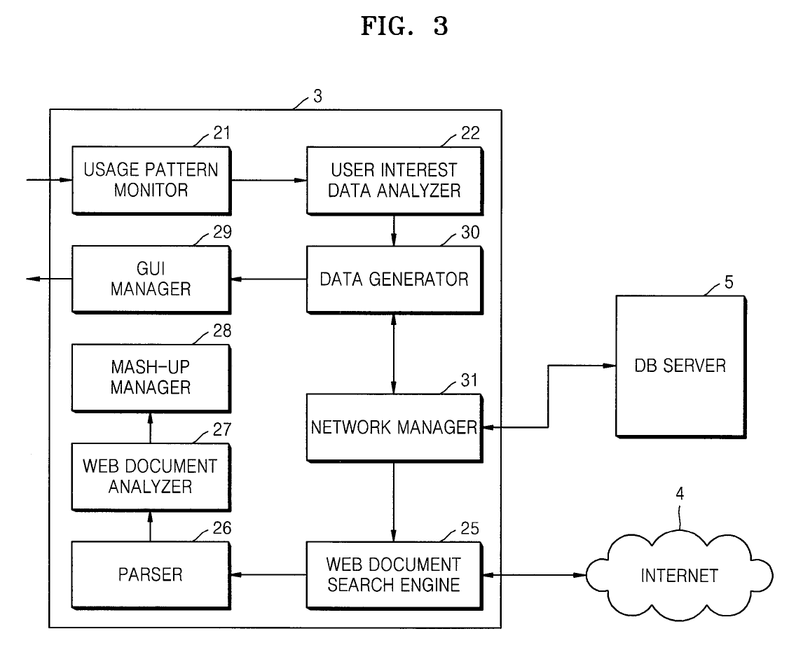

FIG. 3 is a functional block diagram of a browser agent 3 according to another exemplary embodiment of the present invention.

Most elements of the browser agent 3 are the same as the elements of the browser agent 2 in FIG. 2. The browser agent 2 in FIG. 2 includes the database 24 inside while the browser agent 3 in FIG. 3 employs a DB server 5 which is an additional external device as a storage device to store user interest data. Therefore, the browser agent 3 further includes a data generator 30 and a network manager 31 for data communication with the DB server 5.

The data generator 30 converts the user interest data and mashed-up data into a format (protocol) which the DB server 5 can understand.

The network manager 31 manages the data communication between the browser agent 3 and the DB server 5.

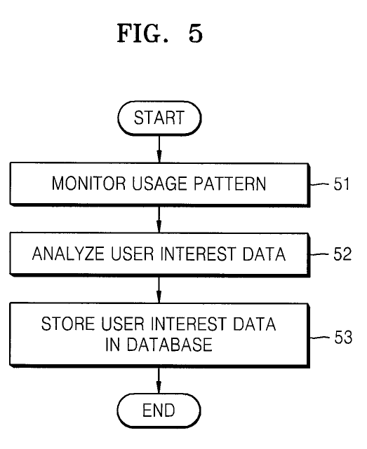

FIG. 5 is a flowchart illustrating a method of acquiring user interest data according to an exemplary embodiment of the present invention.

First, in operation 51, a user's IPTV usage pattern is monitored.

For example, when the user watches live TV using the IPTV, the user selects the function “live TV” using a remote controller and then chooses a desired program with reference to an electronic program guide (EPG). At this time, the usage pattern monitor 21 extracts information (for example, a genre, a title, a producer and a main character of the program) about the program selected by the user from the EPG.

Alternatively, when the user wants to view a VoD using the IPTV, the user clicks content from a VoD content list using the remote controller. Then, the usage pattern monitor 21 extracts information (for example, a genre, a director, a main character and a title of the content) about the selected content from the VoD content list.

Alternatively, when the user operates a browser using the IPTV, the usage pattern monitor 21 collects the URL/URI of a site which the user accessed and texts of the web document which the user clicked.

In operation 52, user interest data is analyzed based on the information about the usage pattern obtained in operation 51.

Keywords are extracted by analyzing the information (for example, information about the program or about the content) about the usage pattern obtained in operation 51 on a word-by-word basis. The extracted key words are to be categorized or arranged.

The reason to arrange the keywords is to make an order of the information based on a certain standard so that the information with a higher priority can be displayed primarily since a single web page has a limited amount of displaying information. There may be various standards for arranging the keywords, and the typical standard is to apply different weights on the keywords and arrange the keywords based on their weights.

A method of applying weights on the keywords may include a method in which different weights are applied on individual functions of the IPTV or a method in which different weights are applied depending on the usage pattern on the same function.

As an example of the method of applying the different weights on individual functions of the IPTV, a higher weight (for example, 3-4 score) is applied to a function when the IPTV acts as a PVR, a browser, or a VoD and a lower weight (for example, 1 score) is applied when the IPTV acts as a live TV. This is because the user is likely to be more interested in a broadcasted program to be recorded using a PVR, a web document to be searched using a browser, or VoD content which has to be paid to watch than usual TV shows which the user simply watches.

As an example of the method of applying the different weights on the same function based on the usage pattern of the user, higher weights are applied to keywords related to texts which are clicked more, the web-sites which the user accesses more often, and the web-sites which the user accesses for a longer period of time even when the IPTV acts as only a browser.

The keywords (or the user interest data) obtained in operation 52 are stored in a database or in an external DB server along with categories and weights (operation 53).

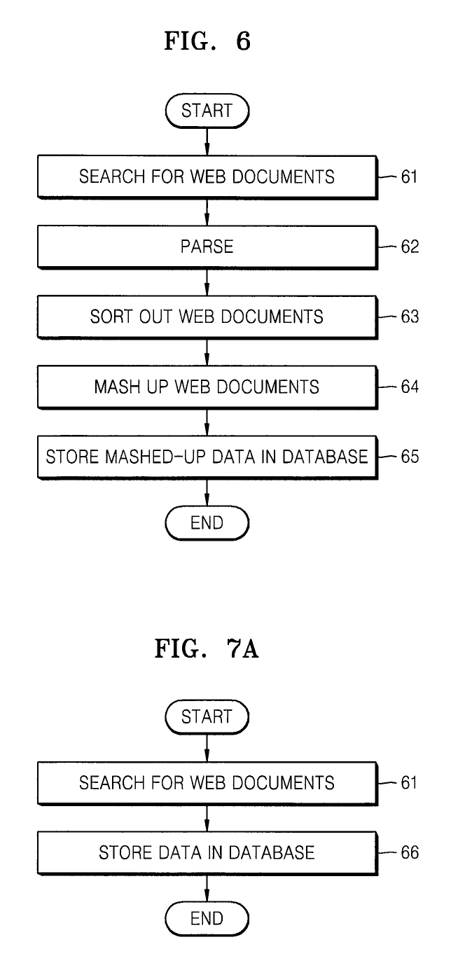

FIG. 6 is a flowchart illustrating a method of mashing-up a web document in detail, according to an exemplary embodiment of the present invention.

The web document mash-up method may be performed regularly with a particular time interval or may be performed whenever the user requests.

Thus, in operation 61, when a web document is about to be searched according to a predetermined interval or there is a user's request, a web document search engine searches the Internet to detect web documents that the user is interested in. At this time, the web document search engine refers to the user interest data stored (in operation 53) in the database or the external DB server. That is, the web document search engine detects only documents which includes the user interest data from the documents existing on the Internet.

In operation 62, a parser parses the web documents detected by the web document search engine so that a web document analyzer can understand the web document.

In operation 63, the web documents are sorted out. The web documents parsed in operation 62 are analyzed and sorted out which documents would interest the user practically.

In operation 64, the documents sorted out by the web document analyzer are mashed-up (or reedited). A mash-up manager removes unnecessary images or contents or changes the size or font of texts in the web documents sorted out in operation 63. That is, the mash-up manager removes contents with regard to Java Script, Ajax, Flash, and moving picture clips which are difficult for the browser of the IPTV to process, or reedits the web document in a format which the browser of the IPTV can display or which is suitable for the browser agent.

The mashed-up data generated by mashing-up is stored in the database or the DB server by a DB manager (operation 65).

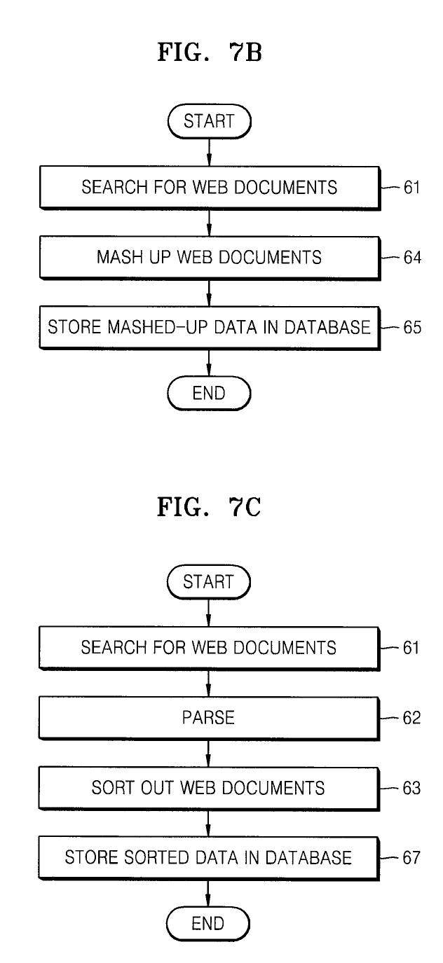

FIGS. 7A-7C are flowcharts each of which illustrates additional exemplary embodiments of the method of searching for a web document according to the present invention. The methods in FIGS. 7A-7C are performed by modifying some procedures of the method of mashing-up the web document in FIG. 6.

For example, in the method in FIG. 7A, operations between 62 and 64 in FIG. 6 are omitted. That is, the web documents detected by using user interest data are directly stored in the database (operation 66) without the parsing procedure (operation 62), sorting out procedure (operation 63) or the mashing-up procedure (operation 64). In the method of FIG. 7B, the parsing procedure (operation 62) and sorting out procedure (operation 63) are omitted. And, in the method of FIG. 7C, the mashing-up procedure (operation 64) is omitted, and parsed and sorted out web documents are stored in the database or DB server by a DB manager (operation 67) without being mashed-up.

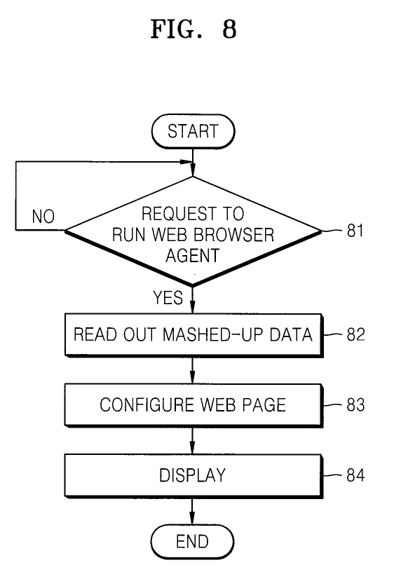

FIG. 8 is a flowchart illustrating a method of displaying customized data in detail, according to an exemplary embodiment of the present invention.

In operation 81, it is determined if there is a user's request for running a browser agent. When the user selects a browser agent menu displayed in the browser while the browser is operating, the browser agent according to the present invention is run.

Once the browser agent is run, the mashed-up data generated by the web document mash-up method (FIG. 6) is read from the database or the DB server (operation 82).

In operation 83, a web page (for example, HTML or XML) is configured to display the customized data according to the selection of the user using the mashed-up data. The example of the web page 41 is shown in FIG. 4.

Referring to FIG. 4, in the left section of the web page 41, category folders 42 which are created based on weights or time and categories 43 displayed with words are shown. In the right section of the web page 42, there are displayed mashed-up data corresponding to a currently selected category. Since the category of “LATEST INTERESTING FOR A DAY” is currently selected in the web page section 42, a plurality of mashed-up data corresponding to the category is displayed in a summarized form in the web page section 44.

The web page configured in operation 83 is displayed in a display unit of the IPTV (operation 84).

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A browser agent of an Internet protocol television (IPTV) which displays customized data, the browser agent comprising:
a usage pattern monitor which monitors a user's usage pattern of the IPTV to obtain usage pattern information; and
a user interest data analyzer which analyzes the usage pattern information obtained by the usage pattern monitor to obtain user interest data on user interests.

2. The browser agent of claim 1, further comprising:
a database which stores user interest data obtained by the user interest data analyzer; and
a database manager which manages data input/output between the user interest data analyzer and the database.

3. The browser agent of claim 1, further comprising:
a data generator and a network manager for data communication between the browser agent and an external database server which stores the user interest data obtained by the user interest data analyzer.

4. The browser agent of claim 1, wherein the user interest data analyzer extracts keywords using the usage pattern information obtained by the usage pattern monitor, and categorizes or arranges the keywords.

5. A browser agent of an IPTV which displays customized data, the browser agent comprising:
a web document search engine which searches for a plurality of web documents with reference to user interest data; and
a mash-up manager which mashes-up the web documents searched by the web document search engine to obtain mashed-up data.

6. The browser agent of claim 5, further comprising:
a web document analyzer which sorts out web documents that a user is interested in from the plurality of web documents searched by the web document search engine.

7. The browser agent of claim 6, further comprising:
a parser which parses the plurality of web documents searched by the web document search engine so that the web document analyzer understands the plurality of web documents.

8. The browser agent of claim 5, further comprising:
a graphic user interface (GUI) manager which configures a web page for displaying customized data using the mashed-up data.

9. The browser agent of claim 5, wherein the IPTV is controlled by a remote controller.

10. A method of acquiring user interest data in order to display customized data on an IPTV, the method comprising:
monitoring a user's pattern of using the IPTV to obtain usage pattern data; and
obtaining user interest data by analyzing the usage pattern data.

11. The method of claim 10, wherein the obtaining of the user interest data comprises extracting keywords by analyzing the usage pattern data on a word-by-word basis.

12. The method of claim 10, wherein in the obtaining of the user interest data, weights are applied to the usage pattern data and then an arrangement order of the usage pattern data is made based on the weights.

13. A method of mashing-up a document in order to display customized data on an IPTV, the method comprising:
searching for a plurality of web documents with reference to user interest data to obtain searched web documents; and
mashing-up the searched web documents.

14. The method of claim 13, further comprising:
sorting out web documents in which a user is practically interested from the searched web documents.

15. The method of claim 13, further comprising:
parsing the searched web documents.

16. The method of claim 13, wherein in the mashing-up of the searched web documents, at least one of procedures of removing unnecessary images from the web document, changing the font of the web documents, and changing the size of texts in the web documents is performed.

17. A method of searching for web documents in order to display customized data on an IPTV, the method comprising:
searching for a plurality of web documents with reference to user interest data to obtain searched web documents; and
storing the searched web documents in a database.

18. The method of claim 17, further comprising:
mashing-up the searched web documents.

19. The method of claim 17, further comprising:
parsing the searched web documents.

20. The method of claim 17, further comprising:
analyzing the searched web documents to sort out web documents in which a user is practically interested.

21. A method of displaying customized data using an IPTV, the method comprising:
reading out mashed-up data;
configuring a web page for displaying the customized data using the mashed-up data; and
displaying the web page.

22. The method of claim 21, wherein the web page comprises sections which display categories and mashed-up data respectively.

23. The method of claim 21, wherein the section which displays the mashed-up data includes one or more pieces of summarized mashed-up data.

24. A computer readable recording medium having embodied thereon a computer program for executing a method of acquiring user interest data in order to display customized data on an IPTV, the method comprising:
monitoring a user's pattern of using the IPTV to obtain usage pattern data; and
obtaining user interest data by analyzing the usage pattern data.

25. A computer readable recording medium having embodied thereon a computer program for executing a method of mashing-up documents in order to display customized data on an IPTV, the method comprising:
searching for a plurality of web documents with reference to user interest data to obtain searched web documents; and
mashing-up the searched web documents.

26. A computer readable recording medium having embodied thereon a computer program for executing a method of displaying customized data using an IPTV, the method comprising:
reading out mashed-up data;
configuring a web page for displaying the customized data using the mashed-up data; and
displaying the web page.

27. A computer readable recording medium having embodied thereon a computer program for executing a method of searching for web documents in order to display customized data on an IPTV, the method comprising:
searching for a plurality of web documents with reference to user interest data to obtain searched web documents; and
storing the searched web documents in a database.
